(19) United States
(12) Patent Application Publication
(10) Pub. No.: US 2026/0013669 A1
(43) Pub. Date: Jan. 15, 2026

(54) COOKING UTENSIL

(71) Applicants: Dusko MARAVIC, Basel (CH); CONDECO TECHNOLOGIES AG, Basel (CH)

(72) Inventor: Dusko MARAVIC, Basel (CH)

(21) Appl. No.: 19/327,247

(22) Filed: Sep. 12, 2025

Related U.S. Application Data
(63) Continuation-in-part of application No. 16/305,651, filed on Nov. 29, 2018, now abandoned.

(30) Foreign Application Priority Data
Jun. 6, 2016 (CH) 00718/16

(51) Int. Cl. A47J 41/02; A47J 36/04

(52) U.S. Cl. CPC A47J 41/022; A47J 36/04

(57) ABSTRACT

A double-walled cooking vessel comprises an inner body and an outer body being arranged into each other with a distance in between and has a flat bottom portion and a wall portion. In the bottom portion a bottom plate is arranged between the two bodies. The two bodies are connected with each other in a vacuum-tight manner and a vacuum exists in between. In a preferred embodiment the bottom portion of the outer body has a recess into which a sandwich of more than one plate is inserted into the recess in vacuum-tight relationship.

### CROSS-REFERENCE TO RELATED APPLICATIONS

The present application is a continuation-in-part of U.S. application Ser. No. 16/305,651, filed Nov. 29, 2018. U.S. application Ser. No. 16/305,651 is a § 371 of PCT/IB2017/000715, filed Jun. 6, 2017.

### FIELD OF THE INVENTION

The present invention is related to a cooking vessel and a method of producing it.

### BACKGROUND OF THE INVENTION

Nowadays most cooking utensils made of high-grade steel are provided with a so-called sandwich base. The technologies applied therefor exclusively include material bonding which is achieved by soldering or so-called beating. In both cases quite high temperatures have to be achieved, so that a secure connection is generated. Usually, a sandwich base consists of an aluminum disc and a so-called capsule which are connected to each other by one of the procedures mentioned above. In other words, the contacting surfaces are connected by a so-called mediation. In the case of soldering this mediation is the suitable solder and in case of the so-called beating it is the atomic bonding forces which hold together the two materials. Nowadays, for obtaining a sandwich base a relatively high energy consumption is required.

The invention is based upon the problem to find a cooking vessel with a better base construction and a method for its production.

These and other objects and advantages of the present invention will become apparent from a reading of the attached specification and appended claims.

### SUMMARY OF THE INVENTION

The present invention is a cooking vessel comprising: an outer body having a flat bottom portion and an upgoing wall portion; an inner body having a flat bottom portion and an upgoing wall portion, the inner body positioned within the outer body such that a space is provided between the upgoing wall portions of the outer and inner bodies and between the flat bottom portions of the outer and inner bodies, each of the outer body and the inner body being pot-shaped; and a bottom plate arranged in the space between the flat bottom portions of the outer and inner bodies, wherein the outer body has an upper rim connected to an upper rim of the inner body in a vacuum-tight manner wherein a vacuum exists between the outer body and the inner body, the bottom plate being in contact with the flat bottom portions of the inner body and the outer body without a material-bonding connection.

In an embodiment, the bottom plate is multi-layered.

In an embodiment, distance holders are arranged between the bottom plate and the bottom portion of the outer body such that a distance is defined between the bottom plate and the flat bottom portion of the outer body.

In an embodiment, the flat bottom portion of the outer body has a recess and the cooking vessel further includes an additional bottom plate inserted into the recess in vacuum-tight relationship. The additional bottom plate may be formed of an electrically-resistive material.

In an embodiment, at least one of the outer and inner bodies is multi-layered. An inner layer of the outer body may be formed of a heat-conductive material. An outer layer of the inner body is may be formed of a heat-conductive material.

In an embodiment, the outer and inner bodies and the bottom plate are assembled in a vacuum chamber.

In an embodiment, the vacuum is generated after the inner body is assembly into the outer body.

The present invention is also a cooking vessel comprising: an outer body having a flat bottom portion and an upgoing wall portion; an inner body having a flat bottom portion and an upgoing wall portion, the inner body positioned within the outer body such that a space is provided between the upgoing wall portions of the outer and inner bodies and between the flat bottom portions of the outer and inner bodies, each of the outer body and the inner body being pot-shaped; and a bottom plate arranged in the space between the flat bottom portions of the outer and inner bodies, wherein the outer body has an upper rim connected to an upper rim of the inner body in a vacuum-tight manner wherein a vacuum exists between the outer body and the inner body, the bottom plate being in contact with the flat bottom portions of the inner body and the outer body without a material-bonding connection. The flat bottom portion of the outer body has a recess, the cooking vessel further comprising a sandwich of more than one plate inserted into the recess in vacuum-tight relationship.

In an embodiment, the sandwich may consist of three layers in intimate and full surface contact with each other and with the inner body of the cooking vessel. The top layer of the sandwich may be a graphite plate, the intermediate layer may be a ferrite plate and the lowest layer may comprise a material with high electrical resistance as well as heat and impact resistivity.

In an embodiment, the lowest layer is configured as a pot-shaped element with the upper layers of the sandwich being arranged within the upgoing wall of the pot-shaped element.

In an embodiment, the sandwich consists of two layers in intimate and full surface contact with each other and with the inner body of the cooking vessel. The top layer of the sandwich may be a graphite plate and the lower layer may comprise a material with high electrical resistance as well as heat and impact resistivity. The lower layer may be configured as a pot-shaped element with the top layer of the sandwich being arranged within the upgoing wall of the pot-shaped element. The inner body may comprise a ferrite material and the top layer of the sandwich is a heat-insulating layer. This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF DRAWINGS

FIG. 1 is a schematic cross-sectional view of a cooking vessel according to the invention.

FIG. 2 is a schematic cross-sectional view of an alternative embodiment.

FIG. 3 illustrates an embodiment with means for a temperature control.

FIG. 4 is a schematic cross-sectional view of a further alternative embodiment.

FIG. 5 illustrates a further embodiment with means for a temperature control.

FIG. 6 illustrates an embodiment with an electro-magnetic shield.

FIGS. 7B and 7B detail variations of the shield shown in FIG. 6.

FIG. 8 illustrates an embodiment of the invention wherein a multilayer sandwich inserted in a recess in the outer body.

FIG. 9 illustrates an embodiment wherein the recess in the outer body is provided with room for vacuum or a heat insulating layer, as well as an optional plate.

FIG. 10 illustrates an embodiment used for types of cooking other than induction, wherein one plate is provided in the recess of the outer body.

### DETAILED DESCRIPTION OF THE INVENTION

The most important feature of the cooking vessel according to the invention is the role of the vacuum with the simultaneous realization of the cooking vessel bottom and the cooking vessel wall. By the effect of the vacuum all the components of the cooking vessel bottom are held together. At the same time the vacuum acts in a double wall of the cooking vessel. The thus generated bottom is particularly efficient für the heat transport into the interior of the cooking vessel, e.g. to the water. The double wall on the other hand effects a an extremely efficient heat insulation, i.e. the heat dissipation of the cooking vessel to the ambient air is minimized to such an extent that almost equal heat technological conditions are achieved as with a so-called thermos flask. The simultaneousness of the effect of the vacuum makes the cooking vessel according to the invention particularly attractive with regard to costs and production.

A further property of the cooking vessel resides in the possibility leading to a temperature-guided control during cooking. The miniaturized electronics with suitable temperature sensors may be arranged in the wall of the cooking vessel with wireless transmission of the measuring values to a regulator connected to the heat source. The actual technology cannot offer a control. It uses a simple steering and tries to simulate the cooking processes as good as possible. At best one may imagine the difference between control and steering in that by control a temperature level in the product to be cooked is given and after reaching the level is held. Steering is a solution which does not function without human assistance. If a cooking process is to be upheld, one chooses by varying the power steps, e.g. between 1 and 10, the one which is optimally useful. Upon every influence from outside it is necessary to adapt the chosen level. Cooking is nowadays always characterized by an approximation to a condition considered as appropriate. Every incorrect procedure in cooking is immediately punished, too much heat, i.e. steam costs money and makes the cooking energetically rather inefficient. This could be replaced by the possibility of a control. Energy-efficient cooking is only possible be temperature-guided control.

For producing the cooking vessel according to the invention, the production sequence needs a rearrangement. The production steps of a conventional operation are arranged as follows: deep-drawing, beveling, cleaning, preparing for the bottom connection, bottom connection, check of the bottom connection with correction, if necessary, mechanical treatment (grinding and polishing), attachment of the handles, cleaning and packing. All these technological steps are used in the production of the cooking vessel according to the invention, but in a somehow varied and reduced sequence.

For producing a cooking vessel according to the invention two raw bodies have to be deep-drawn, one with a smaller diameter and one with a wider diameter. Thereafter follows the beveling and cleaning. These production steps remain unchanged as regards the sequence. The next step is the assembly of the cooking vessel. One or several circular discs are disposed into the wider outer body. Then follows the insertion of the smaller inner body. The next step is the connection of the bodies. This is preferably done in a vacuum chamber with subsequent welding of the pouring rims of the two bodies. The purpose is to generate a vacuum in the space between the two bodies. At the removal from the vacuum chamber and entry into atmospheric pressure the bottom parts are pressed against each other, so that a good connection of all contact surfaces is achieved. The vessel wall is sufficiently strong to withstand a mechanical deformation resulting from the effect of pressure forces. As a rule, the vessel wall should not get into contact with each other. Should this happen however, it would not reduce the quality of the cooking vessel. The vacuum, which is used here, is defined as raw vacuum in the respective technical field. A vacuum higher than a few millibar is not necessary.

The remaining production steps follow unchanged as with the conventional production.

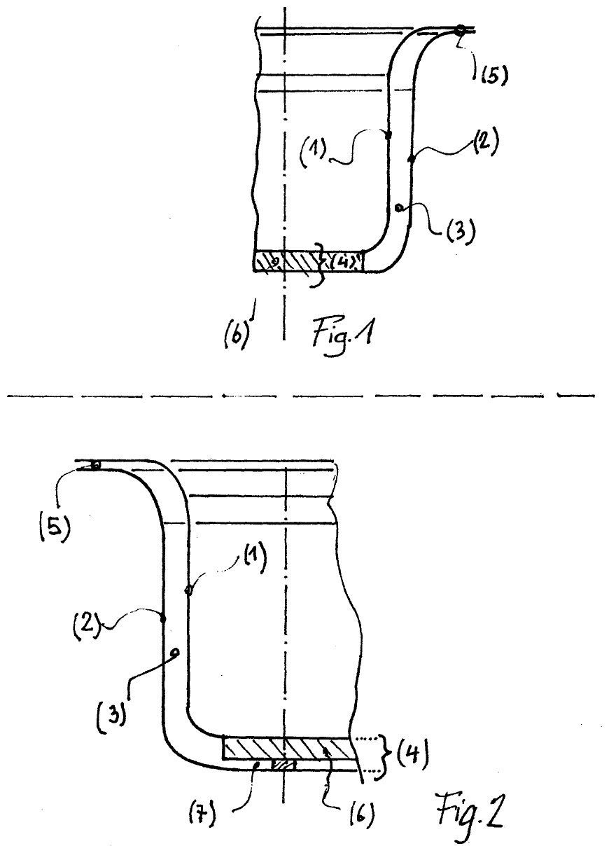

As shown in FIG. 1 the cooking vessel according to the invention is made up of two bodies, inner body 1 and outer body 2, whereby the term “body” connotates a deep-drawn raw body in the shape of a pot. In the entire intermediate space 3 between the two bodies exists vacuum. Preferably, the diameters of the bodies should correspond to the valid standards. This would avoid investment costs for the deep-drawing tools.

With the cooking vessel according to the invention only the pouring rims 5 are connected material-bonded to each other, e.g. by welding, and in the intermediate space 3 exists vacuum. The nature of the material-bonded connection is of secondary importance. After a sufficient vacuum is reached in the intermediate space 5 between the bodies 1 and 2, the pouring rims may be connected to each other. For this purpose, there are various methods available, such as laser welding, electron beam welding, electro resistance welding, soldering, electro-magnetic pulse welding and many more material-bonded connection methods. Of all these bonding methods it is to be expected that after the welding the vacuum in space 3 in the double wall is not lost and will last for a very long time. A connection method such as the electro-magnetic pulse welding should preferably be used for cost reasons, because the energy costs for this bonding method are less than one cent.

In the bottom region the surfaces are pressed against each other due to the vacuum. The one or several circular bottom discs 6 present in the bottom 4 may freely move in radial direction as a consequence of being heated, because they are not material-bonded to the bottom region of the two bodies. This fact significantly contributes to the effect that the bottom 4 is altogether less deformed than in the case that all the components would be connected fixedly, i.e. material-bonded, to each other. By the vacuum in the double wall, it is guaranteed that the heat loss of the cooking vessel is reduced.

Considered under technological and cost-related aspects the connection in the bottom is substantially simpler and significantly cheaper than conventional methods. As this step is a pure cold procedure, the subsequent mechanical treatment is cheaper as well. The surface treatment is reduced to polishing only. The elaborate grinding of colored bottoms 4 due to tempering is obsolete. If the almost 500 centigrade hot vessel bottom is shock-cooled in a water bath a thin hard layer is generated, which has to be removed with increased elaboration. With the solution according to the invention this elaborate mechanical treatment of the bottom is obsolete.

The cooking vessel according to the invention, as described above, is suited for all heat sources including induction, radiation, halogen, mass cooking plates, gas and even open fire. In this sense one may call it a universally usable cooking vessel. It can be called an all-stove cooking vessel.

In overall regard the solution according to the invention is more energy efficient than those with conventional bottom. In particular the actually rather high costs for the bottom configuration are reduced. A relatively small vacuum chamber with e.g a laser needs much less energy for realizing the bottom 4. It is not to be underestimated that the vacuum in the double wall does not have to be prepared in addition. The vacuum enables the realization of the bottom 4 and its presence in the space 3 at the same time. Thus, with the vacuum two issues are realized in one production step, resulting in advantages with regard to time and costs.

Instead of assembling in a vacuum chamber it is also possible to generate a vacuum in the intermediate space after the assembly. For this purpose, a bore is provided at a location of the wall, through which the air is sucked off and which is then closed vacuum-safe.

Due to the bottom connections by vacuum it is possible to use a great variety of materials, even those, which conventionally cannot be materially-bonded. They encompass various composite materials, graphite and graphite composites, suitable ceramics, as well as various metals which for certain reasons cannot be material-bonded.

Preferably such materials are used as circular bottom disks 6 which enable a good heat transport into the interior of the cooking vessel.

In an extreme event, in which the bottom plate could melt due to high temperature, e.g. aluminum, the construction, i.e. the outer body of the cooking vessel, prevents the molten material from getting to the outside. Thus, the possible subsequent damages of such an accident are diminished to a great extent.

The advantages of the solution according to the invention reside not only in the area of production, e.g. the shorter production time and lower production costs but also in its use-specific proprieties. The cooking vessel is mor energy efficient than conventional cooking vessels. It is distinguished by shorter pre-cooking time and lower temperatures of the glass-ceramics if used with radiation heating. With induction it is less noisy and generates much less radiation scattering which as is known is harmful for humans. By choosing suitable materials for the bottom plates, e.g. aluminum, copper, graphite and other materials, a very good temperature distribution can be achieved regardless of the nature of the heat source.

The cooking vessel according to the invention can also be used in combination with the new so-called conduction cooking system. To this end preferably a bottom plate of copper or a copper alloy should be used to achieve an outstanding temperature distribution in the bottom.

The constructive configuration of the solution according to the invention allows the use of various materials for both the outer body 2 and the inner body 1. These materials have to be suitable to be deep-drawn. For the materials for the inner body 1 as opposed to the outer body a nutritional compatibility is required in addition. This is an important prerequisite for fulfilling the valid standard EN 12983-2 for cooking vessels. For the inner bodies 1 preferably refined steel, aluminum, titanium etc. are used. As material for the outer bodies 2 refined steel, aluminum, titanium, copper and copper alloys, glass, suitable ceramic materials and plastics, as well as suitable composite materials are used.

In case that the bodies made of different materials cannot be material-bonded at the pouring rim, they mut be connected in another way. The nature of this connection is secondary as long as the vacuum is upheld for a long time.

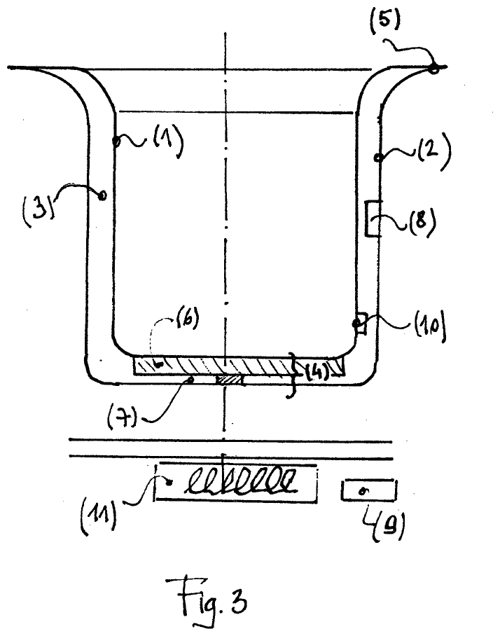

In the embodiment shown in FIG. 2 a bottom intermediate space 7 is provided below the bottom plate 6 in which vacuum is present as well. The presence of vacuum in the bottom region prevents the heat exchange between the warmer inner body 1 and the cooler outer body 2. As the inductive heat is generated in the induction-suited inner body 1, it cannot flow outwards because the bottom intermediate space 7 also stand under vacuum. In an energetic sense this is extremely positive and makes the cooking vessel particularly energy efficient. However, this cooking vessel is not all-stove but only induction suited. In view of the increasing market presence of induction this is not a disadvantage.

The inventive cooking vessel according to FIG. 2, i.e. the cooking vessel which can only be used with induction reaches an even higher energy efficiency and shorter pre-cooking time as compared to the all-stove version according to FIG. 1. The physics behind that is easily to understand: The glass ceramics gets less hot and the heat losses of the bottom get smaller. The amount of heat generated inductively flows almost exclusively to the “customer” in the cooking vessel (products to be cooked, water, oil etc.) and not where it is not needed.

A similar effect is reached if the space 7 in the bottom region 4 is filled with a thermo insulation material.

FIG. 3 shows schematically a cooking vessel according to the invention with integrated electronics and a sensor unit for a temperature-guided control of a cooking system with induction as heat source. The two previously described versions of the cooking vessel according to the invention are suitable for a temperature-guided control of the cooking process. The electronics 8 needed for the control is arranged in the vessel wall of the cooking vessel, preferably at the cooler outer wall. A temperature sensor 10 is directly connected to the inner body to detect the effective temperature of the products to be cooked or the water etc. As exactly as possible. Normally, the sensor will be a commercially available temperature sensor such as Pt-resistors, thermo elements etc. Which transmit their measured values to the electronics 8 in the double wall which in turn transmits them wireless to electronics of the cooking field. The energy needed for the measurement, evaluation and transmission of the signal is provided by a micro coil in the induction cooking field 11.

Thanks to the control the cooking, especially during the actual cooking phase extremely energy efficient. There is only so much heat supplied to the cooking vessel as it transfers to the ambience without lowering the temperature of the content of the cooking vessel. This shows clearly the advantage of the control of the cooking process.

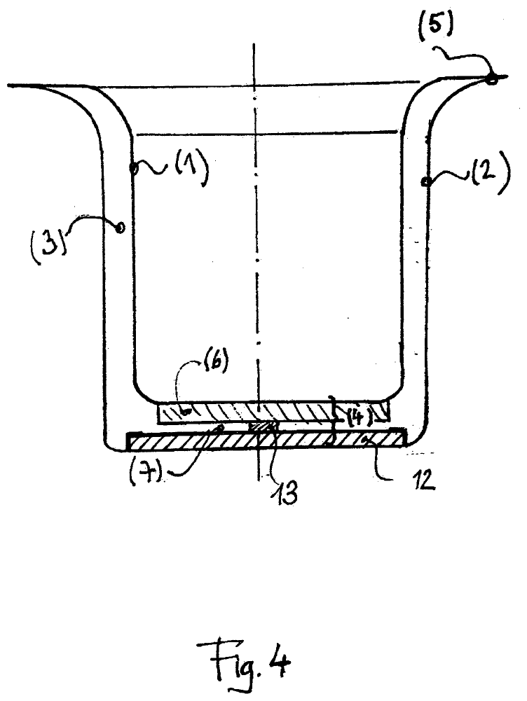

In the embodiment shown in FIG. 4 the outer body 2 is provided with a recess in which an additional lower bottom plate 12 is inserted. This bottom plate is vacuum-tight connected to the outer body, for example by a seal made of silicon caoutchouc. This additional bottom plate is inserted after the deep drawing. For this bottom plate materials with high specific electrical resistance are suited, i.e. for example ceramics and their composites, glass ceramic, glass, plastics etc.

On an induction cooking field this construction prevents the electric field from closing in the bottom region so that the outer body is not heated.

If the lower bottom plate consists preferably of a material with high IR light transparency the cooking vessel can also be used with radiation heating. Due to the low absorption of the lower bottom plate this will be heated only minimal, whereas the main portion of the IR radiation is transformed into heat in the upper bottom plate 6 and is immediately transferred to the products to be cooked.

As an IR light transparent material preferably glass ceramics with high transparency is considered. This material in addition has a high stability, high temperature durability and very high temperature shock stability. With this many requirements which are expected from a cooking vessel can be fulfilled.

Between the upper and the lower bottom plate distance holders 13 are provided. They serve to keep the contact between the two bottom plates in order that the effect of the vacuum exists. The distance holders may e.g. consist of protrusions on the surface of the lower bottom plate. The dimensions of a typical bottom configuration is as follows: For the upper bottom plate 6 a thickness of 0.5 mm would be sufficient for the heating by means of induction. Preferably, however, a thickness of 2 to 3 mm is used. For the lower bottom plate 12 a thickness of 3 mm is preferably suited as well. The distance between the two bottom plated is preferably 1 mm. Variations of these dimensions are possible.

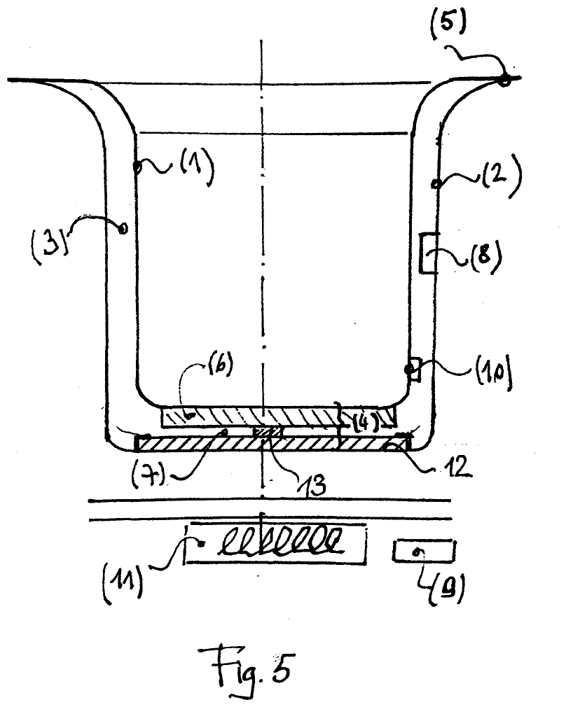

The embodiment shown in FIG. 5 is equally provided with a lower bottom plate 12 inserted in a recess of the outer body, which is provided with the control elements of the embodiment shown in FIG. 3.

The two bodies may also be multi-layered, whereby the layers preferably consist of different materials. The layers do not have to be material-bonded to each other.

If the inner body consists of a layer of refined steel on the side of the products to be cooked and an additional layer of a material with a good heat conduction on the vacuum side, such as aluminum, this has the effect of an improved radial heat distribution in the bottom region and a lower heat dissipation towards the outside in the wall region, i.e. in direction of the vacuum or the outer body.

For the outer body an additional layer with good heat conduction at the vacuum side is advantageous as well, because due to its shielding effect the heating of the austenitic outer layer is prevented or reduced. Especially in the region of the curvature between bottom and wall regions too much heating during induction cooking is thus avoided.

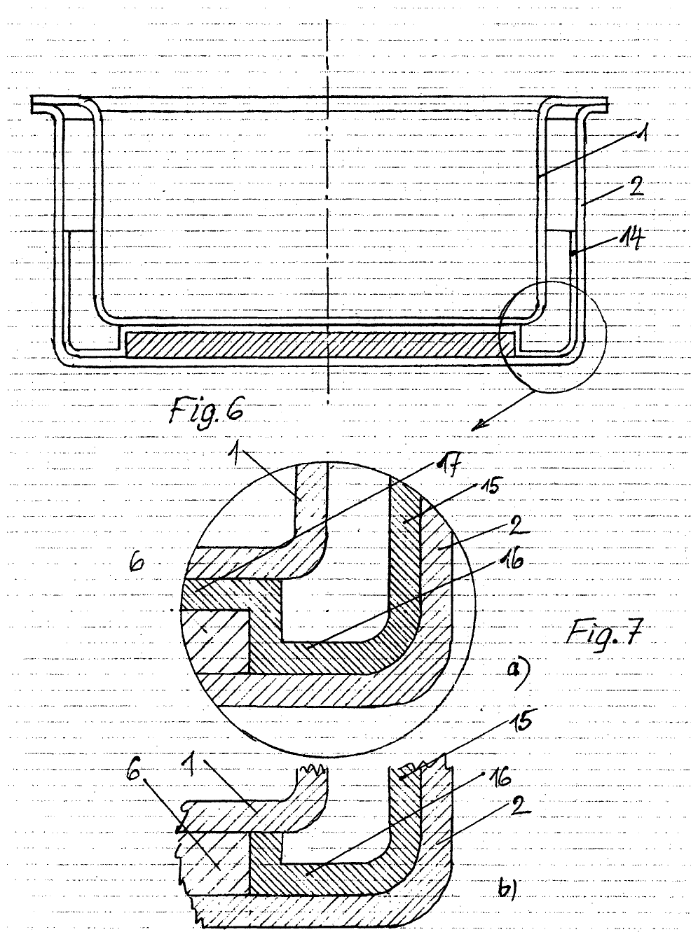

A corresponding embodiment is shown in FIGS. 6 and 7. In addition to the elements described up till now, an electro-magnetic shielding 14 is provided between the inner and outer body. This shielding consists preferably of aluminum. Other materials with similar properties as aluminum may also be used.

As the two bodies the shielding also has the shape of a pot with bottom and wall regions. But the cylindrical wall region 15 of the shielding extends only over a part, e.g. half, of the overall height of the wall. The bottom region of this embodiment is formed such that it has an outer annular portion 16 which contacts the outer body and an inner bottom portion 17 corresponding to the bottom plate 6 and being recessed such that it includes the bottom plate 6 and that its flat portion is positioned between inner body and bottom plate.

The most important function of the shielding is to eliminate the effect of the electro-magnetic field in order to avoid heating of the outer body in the region between its bottom and its vertical portion. The vacuum in the intermediate space, i.e. in the space between the two vessel bodies has an infinitely high electrical resistance so that the electrical field would be closing and heating everything within (Joule's law). This amount of heat would very badly be transferred to the inner body and would cause very high temperatures and damages of the cooking vessel. This is prevented by the shielding at the inner surface of the outer body.

An important prerequisite thereby is that the two part are in contact. There must be no significant gap between the outer body and the shielding. Otherwise, the outer body would be heated as without the shielding.

The electro-magnetic shielding may also be configured annularly as shown in FIG. 7b, i.e. without the bottom region 16. But the effect of the electro-magnetic field in the interior of the cooking vessel, the version with the bottom portion is preferred. A direct “contact” between the electro-magnetic field and the products to be cooked should be avoided. If the shielding is configured without the bottom potion, other measures are known as such to prevent the distribution of the electro-magnetic field in the interior of the cooking vessel.

A further advantage of the shielding resides in the fact that it serves simultaneously for the centering of the bottom plate and keeps the bottom portions of the outer and inner bodies in full surface contact with the bottom plate.

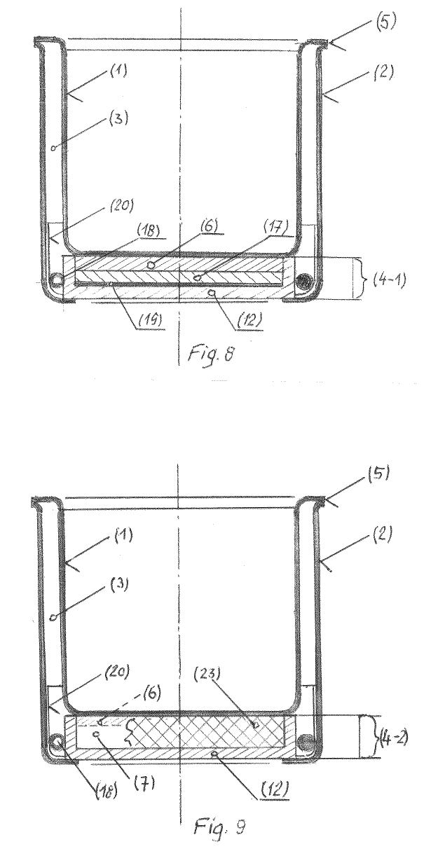

Unlike the embodiment according to FIG. 4, which is provided with a lower bottom plate 12 in addition to bottom plate 6, the embodiment shown in FIG. 8 is provided with a multilayer sandwich inserted in a recess in the outer body 2. The top layer is a graphite plate 6 that is in intimate and full surface contact with the body portion of the inner body 1. This graphite plate could be heated by induction but in this embodiment serves mainly for heat storage. Underneath and in intimate and full surface contact with the graphite plate is an intermediate ferrite plate 17 in which heat is generated by induction. The lowest layer is a pot-shaped element 12 configured with a flat bottom and an upgoing circular wall. This layer consists of a material with high electrical resistance as well as heat and impact resistivity, such as hard or tempered glass, glass ceramics etc. The upper layers 6 and 17 are arranged within the upgoing circular wall of element 12, wherein the intermediate ferrite plate is in intimate and full surface contact with the flat bottom of the pot-shaped lowest layer.

Instead of graphite, plate 6 may as well comprise aluminum, including its alloys, or other materials with good heat conduction property. For improved heat conduction between the layers, a graphite foil 19 may be inserted.

In operation, the electro-magnetic ac field penetrates through layer 6 and induces eddy currents in the ferrite plate 17, thus generating heat which is conducted through the graphite plate and the inner body 1 into the interior of the cooking vessel containing the cooking good.

This embodiment is mainly useful for inductive cooking, but could be used for conventional cooking as well.

The lower surface of element 12 is not level with the lower rim of the outer body 2 in order to avoid heat transfer from the cooking vessel to the upper surface of the induction stove.

The embodiment according to FIG. 9 shows the plate 6 in dashed lines, which is to suggest that plate 6 could be omitted, if the inner body has ferrite properties, so that the heat is generated in the inner body. In this version, the room inside the wall of element 12 is available for vacuum or a heat insulating layer 23 such as thermo paper, pyrogenic silicic acid etc. In case the inner body is not ferrite, a ferrite plate 6 has to be inserted in addition to the vacuum or the heat-insulating layer. In this embodiment, the lower surface of element 12 is also not level with the lower rim of the outer body 2.

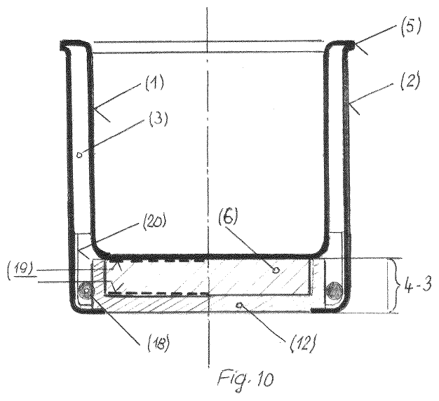

The embodiment of FIG. 10 constitutes a configuration for all types of heating except inductive heating. Unlike the sandwich construction of the embodiments of FIGS. 8 and 9, only one plate 6 consisting of a material with good heat conduction like e.g. graphite, is arranged inside the circular wall of element 12, consisting of glass, glass ceramics etc. In this embodiment, the lower surface of element 12 has to be level with the lower rim of the outer body in order to provide heat conductive contact with the surface of the heat supply.

In all three embodiments shown in FIGS. 8 to 10 the intermediate space between the inner and the outer body is sealed vacuum-tight by a gasket or a sealing mass comprising a material with resistivity against high temperatures, such as e.g. silicone.

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

1. A cooking vessel comprising:
an outer body having a flat bottom portion and an upgoing wall portion;
an inner body having a flat bottom portion and an upgoing wall portion, said inner body positioned within said outer body such that a space is provided between the upgoing wall portions of said outer and inner bodies and between the flat bottom portions of said outer and inner bodies, each of said outer body and said inner body being pot-shaped; and
a bottom plate arranged in the space between the flat bottom portions of said outer and inner bodies, wherein said outer body has an upper rim connected to an upper rim of said inner body in a vacuum-tight manner wherein a vacuum exists between said outer body and said inner body, said bottom plate being in contact with the flat bottom portions of said inner body and said outer body without a material-bonding connection.

2. The cooking vessel of claim 1, wherein said bottom plate is multi-layered.

3. The cooking vessel of claim 1, wherein distance holders are arranged between said bottom plate and the bottom portion of said outer body such that a distance is defined between said bottom plate and the flat bottom portion of said outer body.

4. The cooking vessel of claim 1, wherein the flat bottom portion of said outer body has a recess, the cooking vessel further comprising:
an additional bottom plate inserted into the recess in vacuum-tight relationship.

5. The cooking vessel of claim 4, wherein said additional bottom plate is formed of an electrically-resistive material.

6. The cooking vessel of claim 1, wherein at least one of said outer and inner bodies is multi-layered.

7. The cooking vessel of claim 6, wherein an inner layer of said outer body is of a heat-conductive material.

8. The cooking vessel of claim 6, wherein an outer layer of said inner body is of a heat-conductive material.

9. The cooking vessel of claim 1, wherein said outer and inner bodies and said bottom plate are assembled in a vacuum chamber.

10. The cooking vessel of claim 1, wherein the vacuum is generated after said inner body is assembly into said outer body.

11. The cooking vessel of claim 1, wherein the flat bottom portion of said outer body has a recess, the cooking vessel further comprising a sandwich of more than one plate inserted into the recess in vacuum-tight relationship.

12. The cooking vessel of claim 11, wherein the sandwich consists of three layers in intimate and full surface contact with each other and with the inner body of the cooking vessel.

13. The cooking vessel of claim 12, wherein the top layer of the sandwich is a graphite plate, the intermediate layer is a ferrite plate and the lowest layer comprises a material with high electrical resistance as well as heat and impact resistivity.

14. The cooking vessel of claim 12, wherein the lowest layer is configured as a pot-shaped element with the upper layers of the sandwich being arranged within the upgoing wall of the pot-shaped element.

15. The cooking vessel of claim 11, wherein the sandwich consists of two layers in intimate and full surface contact with each other and with the inner body of the cooking vessel.

16. The cooking vessel of claim 15, wherein the top layer of the sandwich is a graphite plate and the lower layer comprises a material with high electrical resistance as well as heat and impact resistivity.

17. The cooking vessel of claim 16, wherein the lower layer is configured as a pot-shaped element with the top layer of the sandwich being arranged within the upgoing wall of the pot-shaped element.

18. The cooking vessel of claim 17, wherein the inner body comprises a ferrite material and the top layer of the sandwich is a heat-insulating layer.
